(19) United States
(12) Patent Application Publication
(10) Pub. No.: US 2021/0108433 A1
(43) Pub. Date: Apr. 15, 2021

(54) VEHICLE LIFT AND STORAGE SYSTEM HAVING DISTRIBUTED CONTROL AND POWER NETWORKS

(71) Applicant: CityLift Parking, LLC, Oakland, CA (US)

(72) Inventors: Brandon Michael Richardson, Dublin, CA (US); Jian Biao Zhang, Zhuji (CN)

(21) Appl. No.: 17/068,650

(22) Filed: Oct. 12, 2020

Related U.S. Application Data
(60) Provisional application No. 62/914,863, filed on Oct. 14, 2019.

(51) Int. Cl. E04H 6/42; E04H 6/22; G05D 3/20; H04L 29/08

(52) U.S. Cl. CPC E04H 6/422; H04L 67/12; G05D 3/20; E04H 6/22

(57) ABSTRACT

A vehicle lift and storage system (VLSS) can have distributed control and power networks. The VLSS includes a central control unit (CCU) and a plurality of distributed control units (DCUs). Each of the DCUs is associated with and can control one or more vehicle lifts within the VLSS. For instance, each DCU can include high voltage switches (e.g., contactors) for operating one or more motors for moving vehicle platforms on the vehicle lifts associated with that DCU. The CCU can generate and transmit commands to cause the DCU to activate or deactivate the motors in accordance with desired vehicle storage or retrieval operations. Furthermore, the DCUs are configurable to be daisy chained such that a first DCU can communicate with the CCU on the control network via a second DCU and the first DCU can further receive high voltage power for operating its associated motors via the second DCU.

### CROSS-REFERENCE TO RELATED APPLICATIONS

This application claims priority to U.S. Provisional Application No. 62/914,863, filed Oct. 14, 2019, which is related to U.S. patent application Ser. No. 15/890,749, filed Feb. 7, 2018, now U.S. Pat. No. 10,683,676; U.S. patent application Ser. No. 15/890,712, filed Feb. 7, 2018, now U.S. Pat. No. 10,745,928; and U.S. patent application Ser. No. 15/890,691, filed Feb. 7, 2018; each of the aforementioned applications being hereby incorporated by reference in their respective entireties.

### BACKGROUND

Vehicle storage systems can be used to store multiple vehicles in a limited amount of real estate by stacking the vehicles vertically on movable vehicle platforms and thus providing additional storage for vehicles in a given amount of real estate. Vehicle storage systems can comprise of a plurality of platforms that are each moveable (e.g., vertically or transversely) between different positions to enable vehicles to be stored or retrieved. And a plurality of motors can be used to move the platforms between the different positions. Conventional vehicle storage systems utilize a single control unit to control all the motors within the system. In this manner, each of the motors and sensors on each of the platforms within the system are wired directly to the single control unit of the system. In addition, the motors are also coupled to a high voltage power source to receive power.

Because the structures and spaces into which vehicle storage systems are installed are each unique in terms of size and floorplan, the installation and wiring of vehicle storage systems (e.g., low voltage signal lines coupling motors and sensors to the single control unit and/or high voltage power lines coupling motors to the high voltage power source) must be performed in a manner that is customized for the installation space and can be particularly challenging, time consuming, and costly. Furthermore, as the system size (e.g., number of platforms and motors) is increased, the challenge to connect the various components of the vehicle storage system becomes even more complex. Moreover, in such systems, the control and power lines can be long and a single malfunction in anywhere on a line can necessitate costly and time-consuming troubleshooting of the entire length of the line. Furthermore, the replacement of a custom-installed signal line or power line can be costly and time-consuming. Still further, as the system size is increased, the physical size of the single control unit must also be increased to accommodate the increased size and complexity of the control circuitry (e.g., circuitry to control the motors and receive and process sensor data) as well as the increased number of interconnections required. Thus, the vehicle storage system capacity can be constrained by the single control unit that can be built or installed. In addition, such constraints can limit the ability and flexibility for operators and owners of these vehicle storage systems to add additional parking spaces to the vehicle storage systems after initial installation of the vehicle storage system.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example vehicle lift and storage system (VLSS) having distributed control and power networks, in accordance with examples described herein;

FIG. 2 is a block diagram illustrating a central control unit (CCU) within a vehicle lift and storage system having distributed control and power networks, in accordance with examples described herein;

FIG. 3 is a block diagram illustrating distributed control units (DCUs) within a vehicle lift and storage system having distributed control and power networks, in accordance with examples described herein;

FIG. 4 is a flow chart describing an example method of performing a vehicle storage operation, according to examples described herein;

FIG. 5 is a flow chart describing an example method of performing a vehicle retrieval operation, according to examples described herein; and

FIG. 6 is a block diagram illustrating a computer system upon which examples described herein may be implemented

### DETAILED DESCRIPTION

Examples described herein provide for a vehicle lift and storage system (“VLSS”) that comprise a plurality of vehicle lifts. Each of the vehicle lifts can include one or more platforms that are movable between a plurality of available positions to allow vehicles to be stored in and retrieved from the VLSS. Depending on the specific implementation, the platforms can be moved vertically and/or horizontally. The VLSS can also include one or more moving mechanisms (e.g., electromechanical motors, linear motors, etc.) that are operatively connected (e.g., via chains, cables, belts, etc.) to the platforms to move the platforms (e.g., vertically, horizontally, or both) between the plurality of positions. In some implementations, a platform can be operatively coupled to more than one moving mechanisms: one to move the platform vertically, and another to move the platform horizontally or transversely. In addition, an additional moving mechanism(s) can be provided for opening and closing a safety gate of the VLSS.

According to embodiments, the VLSS includes a distributed architecture comprising a central control unit (“CCU”) and a plurality of distributed control units (“DCUs”). Each DCU can control one or more moving mechanisms for one or more vehicle lifts of the VLSS. The DCUs can be daisy chained such that at least a subset of the distributed control units of the VLSS are communicatively coupled to the central control unit via other DCUs. For instance, a CCU can directly communicate with a first set of DCUs (e.g., signals and data transmitted by the CCU to and from the first set of DCUs do not have to be routed or forwarded by other DCUs), and a second set of DCUs can be communicatively coupled with the CCU via the first set of DCUs, and a third set of DCUs can be communicatively coupled via the first and second sets of DCUs.

According to embodiments, control and sensor signals and data as well as high voltage power can be transferred between daisy chained DCUs. As described herein, signal lines, cables, conductors, and/or network connections within the VLSS for carrying control signals (e.g., signals for controlling the motors, gates, and other components of the VLSS) and for transferring sensor data (e.g., from contact sensors, accelerometers, gyroscopes, cameras, etc.) are referred to as the control lines or as low voltage lines. And the control lines or low voltage lines—which can carry control signals and data between the DCUs, various sensors, and/or the CCU—are collectively referred to as the control network of the VLSS or as the low voltage network of the VLSS. The high voltage power lines within the VLSS—which can carry high voltage power from a high voltage power source for powering the moving mechanisms—are collectively referred to as the power network of the VLSS or as the high voltage network of the VLSS.

According to some examples, the CCU of the VLSS can perform higher-level functions such as receiving user requests to store or retrieve vehicles, authenticating users, communicating with user devices, communicating with a cloud or network-based service (e.g., a cloud service for managing reservations across a plurality of vehicle storage facilities), determining a vehicle storage assignment in response to a user request to store a vehicle, maintaining records of vehicles being stored in the VLSS (e.g., associating users and/or vehicles to vehicle storage assignment records), querying a vehicle storage assignment in response to a user request to retrieve a vehicle, maintaining troubleshooting and maintenance data for the VLSS, receiving and processing remote commands from system administrators, and the like. The DCUs of the VLSS, on the other hand, can perform lower-level functions such as controlling the moving mechanisms in response to one or more commands from the CCU, receiving sensor data in controlling the moving mechanisms (e.g., stopping the moving mechanisms in response to receiving sensor data indicating unexpected contact of the platform being moved, etc.), transmitting relevant data (e.g., sensor data, maintenance information, error codes, troubleshooting information, etc.) to the CCU, etc. The DCUs can also act as nodes on the control network to forward commands, signals, and data between the CCU and other DCUs, or between DCUs. The DCUs can further pass through high voltage power to other DCUs.

According to embodiments, a given DCU can include connectors for daisy chaining with other DCUs: at least one for coupling with an upstream DCU (e.g., another DCU via which the given DCU communicates with the CCU) or the CCU, and at least another for coupling with a downstream DCU (e.g., the downstream DCU communicates with the CCU via the given DCU). In some examples, a single connector is used to couple both control lines and high voltage power lines from one DCU to another. In other examples, separate connectors can be used for control lines and high voltage power lines. For instance, for a first DCU, a first connector is provided for coupling with an upstream DCU (or the CCU) for carrying low voltage signals. A second connector is provided on the first DCU for coupling with the upstream DCU (or a high voltage power supply) to receive high voltage power for supplying power for the moving mechanisms controlled by the first DCU and the DCUs that are downstream to the first DCU. A third connector is provided for coupling with the downstream DCU for transferring low voltage signals to the downstream DCU (and other DCUs further downstream from the downstream DCU). Furthermore, the first DCU can include sensor input/output (I/O) to receive sensor data from sensors on the vehicle lift(s) the DCU controls. The first DCU can further supply power to the sensors via the sensor I/O.

Each DCU can include circuitry and components to pass through control signals, sensor data, and high voltage power to another DCU to allow for the daisy chaining of DCUs. For instance, each DCU can include high voltage pass through circuitry for safely routing high voltage power to a downstream DCU. Each DCU can further include circuitry to route sensor data and other control signals. In addition, each DCU can include high voltage switches (e.g., contactors) for controlling one or more moving mechanisms of vehicle lifts with which the each DCU is associated.

In various aspects, components of the distributed architecture of the VLSS, such as the CCU, the DCUs, and the high voltage power supplies, can be modular. This distributed and modularized architecture improves the VLSS in numerous ways in comparison with existing systems. For example, with existing systems, a larger vehicle storage system may require an entirely different control and power network in comparison to a smaller one. For instance, the single control unit utilized in existing systems may need to be custom designed for the number of vehicle lifts and/or moving mechanism it controls (e.g., in terms of control circuitry and number of interconnections). As an example, a single control unit can be designed to control up to 64 motors. A VLSS requiring more than 64 motors must have a different single control unit to accommodate the additional motors. The layout of the wiring of the control and power networks in existing systems also need to custom designed. Existing systems are also inflexible in terms upgradeability. For example, an existing system may have a capacity of 64 units (e.g., 64 platforms and 64 motors). The existing system may be controlled by a single control unit that also has a maximum capacity of 64 (e.g., the single control unit can be physically connected to no more than 64 motors). To upgrade such a system beyond its existing capacity of 64 units, the single control unit will have to be replaced (at great cost). Alternatively, another control unit can be installed to control the additional motors and platforms to be installed. But the two control units will then operate separately from each other and can cause inconveniences to users.

In comparison, utilizing the distributed architecture, a larger distributed VLSS (having more vehicle lifts and/or vehicle platforms) can simply include additional DCUs (and/or high voltage power supplies) as compared to a smaller distributed VLSS. In addition, because the DCUs can be daisy chained, the complexity of the layout of the wiring of the control and power networks is much reduced. Furthermore, as part of the distributed and modularized architecture, the vehicle lifts of the VLSS can include cable rails or guides for routing high voltage power lines and/or low voltage signal lines. In this manner, the need for custom wiring of the control network and/or the power network can be effectively eliminated.

Moreover, the distributed configuration of the VLSS described herein that includes a CCU and a plurality of DCUs enable the installation of the VLSS to be more cost and time effective. In particular, the distributed control and power networks, in combination with premanufactured cable guides and harnesses provided on the vehicle lifts enable much more efficient and cost-effective installations of VLSS's. The distributed architecture of the VLSS enables various components of the VLSS (such as the CCU and DCU) to be modular and utilized across a variety of VLSS designs and sizes—a larger VLSS can simply include additional DCUs to control the additional vehicle lifts. This simplifies the manufacturing process and eliminates the need for control units that are custom designed for a given number of vehicle lifts and/or vehicle platforms within the VLSS. Furthermore, for a large VLSS, the CCU need not accommodate as many interconnections and control circuitry as compared to the single control unit in existing systems thereby saving installation space (e.g., by avoiding the need for a single large control unit that needs to be physically installed in space constrained environments). Furthermore, by enabling additional vehicle lifts to be installed by simply adding additional DCUs to the control network, the distributed architecture of the VLSS described herein further enables additional flexibility to VLSS operators and/or owners in expanding an existing VLSS.

Additionally, the distributed architecture of the VLSS can provide benefits with respect to troubleshooting and repair of various components of the VLSS. For instance, troubleshooting and repair of components of the VLSS can be more efficient and cost-effective. In existing systems, a fault on a signal line between the single control unit can require the replacement of the entire line, which can be expensive. In comparison, with the distributed architecture of the VLSS, troubleshooting can be more efficient because long cables running from the single control unit of existing systems can be eliminated. Furthermore, cables can be prefabricated rather than custom designed to length, making any repairs more cost effective. In addition, the distributed architecture enables modular components (such as the DCUs), thereby making eliminating the need for a single, expensive control unit.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Descriptions

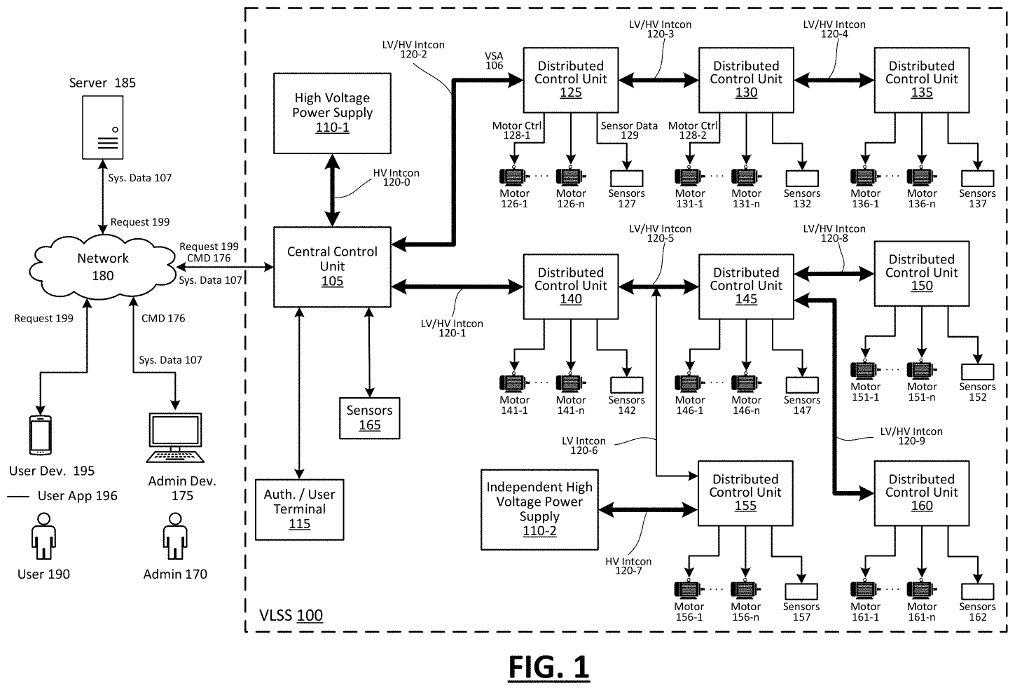

FIG. 1 is a block diagram illustrating an example vehicle lift and storage system (VLSS) having distributed control and power networks, in accordance with examples described herein. The VLSS 100 includes a plurality of vehicle lifts (not illustrated in FIG. 1 for simplicity) each having one or more vehicle platforms that are movable between different positions for vehicle loading and unloading. The vehicle lifts can be configured in various manners (e.g., as vertical lifts, puzzle lifts, or as tower lifts).

In the examples described herein, the VLSS 100 can be configured in a distributed manner that includes a central control unit (CCU) 105 and a plurality of distributed control units (DCUs) 125, 130, 135, 140, 145, 150, 155, and 160. The CCU 105 can be configured to perform or manage at least parts of various higher level functions of the VLSS 100, such as authenticating users, determining and/or assigning storage slots for vehicles, receiving diagnostic data from various components of the VLSS 100, maintaining maintenance records, and the like.

In certain implementations, the CCU 105 can communicate with an authentication terminal 115 to receive an authentication token 116. The authentication terminal 115 can transmit the authentication token 116 in response to authenticating a user 190. The authentication terminal 115 can be a user terminal or kiosk located on the premises of the VLSS 100 to allow users to interact with the system (e.g., via a touchscreen user interface) to submit requests for vehicle storage or retrieval operations. For a vehicle retrieval operation, the user 190 can interact with the authentication terminal 115 to provide identification and/or authentication information (e.g., input a user ID and/or an authorization code, using a proximity card, scan or input a code, barcode, or QR code generated by an application executing on a user device 195, etc.) to enable the VLSS 100 to identify the platform that stores the user 190's vehicle and move that platform to a position to enable the user 190 to retrieve the vehicle. The authentication terminal 115 can further inform the user 190 the location of the user 190's vehicle after the retrieval operations are completed. The authentication terminal 115 can additionally be a wireless gateway for receiving signals transmitted by, for example, wireless key fobs or Bluetooth devices. As an example, the user 190 can simply activate a wireless key fob associated with the user 190 within the premises of the VLSS 100 to transmit a wireless signal that serves as a vehicle storage operation request. The authentication terminal 115 receive the wireless signal, identifies and authenticates the user 190 based on the received wireless signal, and transmits an authentication token 116 to the CCU 105. In response, the CCU can perform vehicle storage operations for the user 190. Although FIG. 1 illustrates a single authentication terminal 115, the VLSS 100 can be configured with a plurality of authentication terminals.

In certain embodiments, the CCU 105 can include one or more network interfaces for communicating over a network 180 such as the Internet. The CCU 105 can communicate with the user device 195 of the user 190. The user device 195 can execute a dedicated user application 196 for interacting with the VLSS 100. In some implementations, the user application 196 can interact with a cloud-based service implemented on a server 185 for managing multiple vehicle parking structures such as VLSS 100. Using the user application 196, the user 190 can cause the user device 195 to transmit, via the network 180, a request 199 either to the server 185 implementing the cloud-based service or to the CCU 105. The request 199 can be either a request for vehicle storage operation or a request for vehicle retrieval operation. The cloud-based service or the CCU 105 can authenticate the user based on the request 199 or other identification or authentication information transmitted by the user device 195. In addition or as an alternative, the user device can transmit a vehicle storage or retrieval request to the cloud-based service which can, in turn, transmit a request over the network to the CCU 105. The CCU 105 can, in response to the request 199, (i) determine a vehicle platform assignment for a request 199 corresponding to a vehicle storage request to store the user 190's vehicle, or (ii) identify the platform on which the user 190's vehicle is currently stored for a request 199 corresponding to a vehicle retrieval request to retrieve the user 190's vehicle. In some examples, the server 185 can determine a vehicle storage assignment (e.g., indicating the vehicle lift and/or the vehicle platform on which the user 190's vehicle is to be stored) based for example on the user 190's identity and/or parameters associated with the user 190 for the cloud-based service (e.g., a reservation or subscription for a particular vehicle lift and/or platform via the cloud-based service). In other examples, the CCU 105 can determine the vehicle storage assignment based for example on the user 190's request (e.g., requested duration of storage indicated by the request 199).

In certain implementations, the CCU 105 can also communicate with a server 185 via a network interface. The server 185 can implement a cloud or network-based service for operating and managing a plurality of vehicle storage facilities (each of which can be one or more vehicle storage systems such as the VLSS 100). The cloud or network service can enable a uniform and consistent user access and experience across the plurality of vehicle storage facilities managed by the cloud or network service. In doing so, the server can maintain a corresponding user profile for each of a plurality of users. The cloud or network-based service can also process financial transactions and handle parking reservations associated with the users' use of the VLSS's.

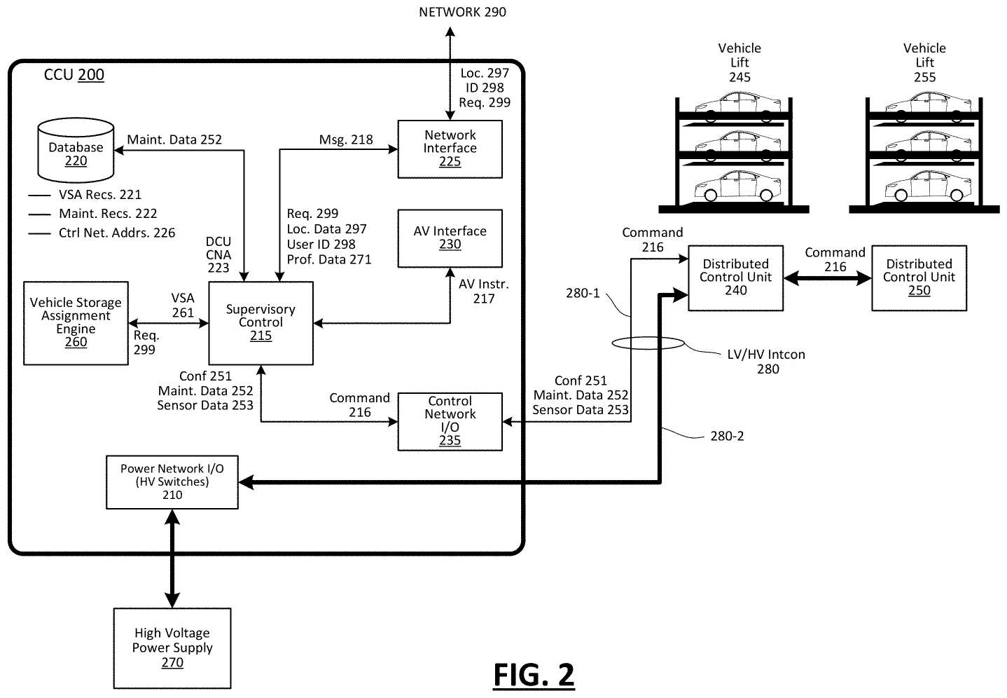

In certain implementations, the CCU 105 can further communicate with an administrator device 175 of an administrator 170 via the network 180 or via a local connection. The CCU 105 can maintain maintenance and troubleshooting information of individual components of the VLSS 100 (e.g., motors, sensors, safety gates, etc.) that can be accessed by the administrator 170 using the administrator device 175. The maintenance and troubleshooting information can include or be derived from data transmitted to the CCU 105 from each of the DCUs in the VLSS 100 (e.g., an error code generated by motor 126-1 that is received by DCU 125 and transmitted to the CCU 105 by DCU 125). The administrator 170 can remotely access the maintenance and troubleshooting information over the network 180 and can perform certain troubleshooting or mitigating functions remotely via the administrator device 175 by transmitting commands to the CCU 105 (e.g., commands to power off, reset, or reboot one or more components of the VLSS 100 remotely). Additional details of an exemplary CCU 105 are illustrated in and described with respect to FIG. 2.

According to embodiments, each of the DCUs can be associated with and can control one or more vehicle lifts of the VLSS 100, including the moving mechanisms of the vehicle lifts. In comparison to the CCU 105, the DCUs can be configured to perform lower level functions such as controlling the moving mechanism(s) of vehicle lifts, receiving and processing sensor data, and receiving and processing maintenance, diagnostic, or error information for the components that the DCUs control. For example, DCU 125 illustrated in FIG. 1 can be associated with a first vehicle lift of VLSS 100. The DCU 125 can control a motor 126-1 that is configured to move one or more vehicle platforms of the first vehicle lift between a plurality of positions (e.g., by generating a motor control signal 128-1). The DCU 125 can perform these functions based on the signals received from the CCU 105 (e.g., vehicle storage assignment (VSA) 106 for the user 190, etc.). The DCU 125 can further operate one or more other motors for the first vehicle lift (e.g., a motor configured to open or close a safety gate of the first vehicle lift, a motor configured to move other vehicle platforms of the first vehicle lift, etc.) such as motor 126-n. The DCU 125 can also be configured to receive data from sensors attached to or associated with the vehicle lift(s) it controls (e.g., sensors 127 associated with the first vehicle lift). The DCU 125 can further control the motor 126-1 based at least in part on the sensor data received from the sensors 127 (e.g., sensor data 129). For instance, the DCU 125 can cause the motor 126-1 to stop operating if the sensor data from the sensors 127 indicate an anomaly during operations to a vehicle platform. Each of the DCUs 125, 130, 135, 140, 145, 150, 155, and 160 can also include circuitry to safely pass through high voltage power to one or more other DCUs. In addition, the CCU 105 can further communicate with a suite of sensors 165 in addition to those associated with specific vehicle lifts (e.g., sensors 127, 132, etc.). The sensors 165 can include cameras, motion detectors, IR sensors, and the like that monitor various areas of the structure in which the VLSS 100 is located.

As further illustrated in FIG. 1, DCU 130 controls motors 131-1 to 131-n and receives sensor data from sensors 132; DCU 135 controls motors 136-1 to 136-n and receives sensor data from sensors 137; DCU 140 controls motors 141-1 to 141-n and receives sensor data from sensors 142; DCU 145 controls motors 146-1 to 146-n and receives sensor data from sensors 147; DCU 150 controls motors 151-1 to 151-n and receives sensor data from sensors 152; DCU 155 controls motors 156-1 to 156-n and receives sensor data from sensors 157; and DCU 160 controls motors 161-1 to 151-n and receives sensor data from sensors 162. Additional details of exemplary DCUs are illustrated in and described with respect to FIG. 2.

As described herein, the VLSS 100 can include a control network (also referred to as the low voltage network) for carrying low voltage analog signals and/or digital signals. Various components of the VLSS 100 can be coupled to the control network to transmit and receive sensor data, control signals, calibration signals, and the like. Although described herein as a singular term, depending on the implementation, the control or low voltage network can comprise a plurality of disparate networks. For instance, a first network can be used to transmit and receive sensor data while a second network can be used to transmit and receive control signals. In some implementations, the control network can further include low voltage power lines that can be used to supply power to sensors, microprocessors, networking components, etc. within the VLSS 100. The VLSS 100 can further include a power network (also referred to as the high voltage network) for carrying high voltage power for powering moving mechanisms for moving vehicle platforms, movable doors, and the like. The voltage on the power network is typically much higher compared to the control network. For instance, the signal lines of the control network can have voltages that range from 3V to 48V while the power lines on the power network can carry electric current having voltages up to 600V.

According to examples, components of the VLSS 100 can be arranged and configured in a distributed manner with respect to the control network such that a central control unit (CCU) 105 communicates over the control network with a plurality of distributed control units (DCUs) to transmit and receive low voltage signals such as control signals and sensor data. Depending on the particular implementation, the DCUs can be daisy chained such that some of the DCUs communicate with the CCU indirectly via one or more other DCUs. DCUs can also communicate amongst each other via the distributed control network. For instance, as illustrated in FIG. 1, DCU 125 can communicate with CCU 105 via low voltage/high voltage interconnect (“LV/HV Intcon”) 120-2 but DCU 130 indirectly communicates with CCU 105 via DCU 125 and DCU 135 indirectly communicates with CCU 105 via DCUs 130 and 125.

According to embodiments, components of the VLSS 100 can further be arranged and configured in a distributed manner with respect to the power network such that DCUs can be daisy chained to receive high voltage power via other DCUs. For instance, as illustrated in FIG. 1, DCUs 125 and 140 receive high voltage power from high voltage power supply 110-1 whereas DCUs 130 and 145 receive high voltage power via DCUs 125 and 140, respectively.

The CCU, DCUs, and one or more high voltage power supplies can be connected by low voltage interconnects (for carrying low voltage signals such as control signals, sensor data, etc., e.g., LV Intcon 120-6) and/or high voltage interconnects (for carrying high voltage power, e.g., HV Intcon 120-0 and 120-7). In some implementations, where both low voltage signals and high voltage power are routed between two DCUs, a low voltage/high voltage interconnect (“LV/HV Intcon”) can be used to carry both the low voltage signals and the high voltage power. An LV/HV Intcon (e.g., LV/HV Intcons 120-1, 120-2 120-3, 120-4, 120-5, 120-8, and 120-9) can be a pre-fabricated combination interconnect that combines both low voltage signal line(s) and high voltage power line(s). Such a combination interconnect can further include one or more combination connectors that can each serve as a single connection point for both low voltage signals and high voltage power. In FIG. 1, one or more of LV/HV Intcons 120-1, 120-2 120-3, 120-4, 120-5, 120-8, and 120-9 can be implemented as such combination interconnects. In other implementations, one or more of LV/HV Intcons 120-1, 120-2 120-3, 120-4, 120-5, 120-8, and 120-9 can be implemented as a combination of separate low voltage interconnects and high voltage interconnects.

In the configuration illustrated in FIG. 1, with respect to the control network, DCU 125 communicates with the CCU 105 via the LV/HV Intcon 120-2; DCU 130 communicates with the CCU 105 via LV/HV Intcon 120-3 and DCU 125; DCU 135 communicates with the CCU 105 via LV/HV Intcon 120-4 and DCUs 130 and 125; DCU 140 communicates with the CCU 105 via the LV/HV Intcon 120-1; DCU 145 communicates with the CCU 105 via the LV/HV Intcon 120-5 and the DCU 140; DCU 150 communicates with the CCU 105 via the LV/HV Intcon 120-8 and the DCUs 145 and 140; DCU 155 communicates with the CCU 105 via the LV Intcon 120-6 and the DCU 140; and DCU 160 communicates with the CCU 105 via the LV/HV Intcon 120-9 and the DCUs 140 and 145.

Furthermore, in the exemplary configuration illustrated in FIG. 1, with respect to the power network, high voltage power supply 110-1 is coupled to the CCU 105 via HV Intcon 120-0 to supply power to each of the DCUs in the VLSS 100 except DCU 155. In other implementations of the VLSS, a single power supply can supply high voltage power to each of a plurality of DCUs within the VLSS. In the illustrated configuration, high voltage power supply 110-1 transmits high voltage current (e.g., 480 V three-phase AC current) to the CCU 105 via HV Intcon 120-0. The CCU 105 then distributes the high voltage current to each of the DCUs of the VLSS 100, except DCU 155, via respective low voltage/high voltage interconnects. Furthermore, DCUs can further route power to other DCUs via respective low voltage/high voltage interconnects. As illustrated in FIG. 1, DCU 125 receives high voltage power from the CCU 105 via LV/HV Intcon 120-2; DCU 125 routes high voltage power to DCU 130 via LV/HV Intcon 120-3; DCU 130 routes high voltage power to DCU 135 via LV/HV Intcon 120-4; DCU 140 receives power from the CCU 105 via LV/HV Intcon 120-1; DCU 140 routes high voltage power to DCU 145 via LV/HV Intcon 120-5; and DCU 145 routes high voltage power both to DCU 150 (via LV/HV Intcon 120-8) and to DCU 160 (via LV/HV Intcon 120-9).

Depending on the variation, the CCU 105 can include high voltage switches to selectively turn off power to one or more of the DCUs. For example, the CCU 105 can selectively turn off high voltage power to DCUs 125, 130, and 135 (e.g., in response to one or more commands transmitted by the administrator 170 using the administrator device 175 transmitted via network 180) while keeping the other DCUs of the VLSS 100 in service.

In certain implementations, the VLSS 100 can further include one or more independent high voltage power supplies that can directly provide high voltage current to one or more DCUs (instead of transmitting high voltage power to DCUs via the CCU 105 as high voltage power supply 110-1 does). In the example illustrated in FIG. 1, independent high voltage power supply 110-2 transmits high voltage power to DCU 155 via HV Intcon 120-7.

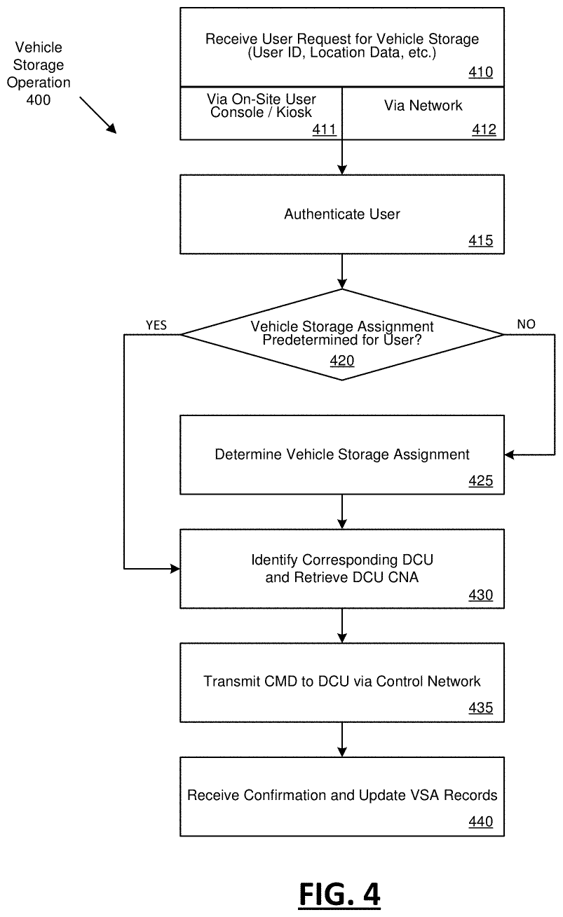

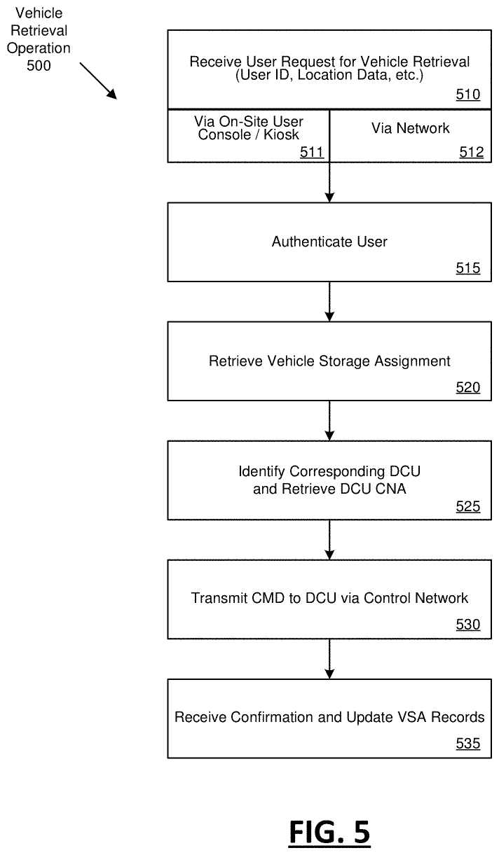

In certain implementations, the distributed control network can be implemented using a packet-based or message-based protocol (e.g., ethernet, controller area network (CAN), etc.) where control signals, sensor data, calibration signals and the like are transmitted in the form of packets. Each of the nodes of the distributed control network can have a unique identifier or address (e.g., a control network identifier or CNI) for use in communicating on the control network. The CCU 105 can maintain an address directory that associates each component (e.g., a DCU) on the control network with its CNI. In this manner, the CCU 105 can communicate with any given DCU on the distributed control network using the CNI of the given DCU to instruct the given DCU to operate a particular motor associated with the given DCU. Examples of how the CCU 105 communicates with DCUs during vehicle storage or retrieval operations are illustrated in and described with respect to, for example, FIGS. 4 and 5.

In some implementations, an edge computer or an edge server (not illustrated in FIG. 1 for) can be implemented within the VLSS 100. In such implementations, the CCU 105 can communicate via the network 180 (e.g., with server 185, user devices 195, and administrator device 175) through the edge computer. Commands 176 from the administrator device 175 or a request 199 from the user device 195 and/or the server 185 can be received over the network 180 by the edge computer and in turn communicated to the CCU 105 by the edge computer. As an example, the edge computer can receive a command 176 over the network 180. The command 176 can be received from the administrator device 175 or from the server 185. The command 176 can correspond to an instruction to power off a portion of the VLSS 100 (e.g., a specific vehicle lift within the VLSS 100, a set of vehicle lifts within the VLSS 100). In addition or as an alternative, the command 176 can correspond an instruction to disable a specific position of a given vehicle platform such that the given vehicle platform is no longer able to be moved into that specific position. In certain implementations, the administrator device 175 and/or the server 185 can execute one or more programs that continuously monitor system data 107 transmitted by the VLSS 100 over the network 180 (e.g., by the CCU 105 or by the edge computer). The system data 107 can be real-time data and can include fault codes, maintenance data, and performance and usage data relating to the VLSS 100. In certain examples, the administrator device 175 and/or the server 185 can executed one or more programs that monitor the system data 107 received from the VLSS 100 to automatically transmit commands 176 in response to the system data 107. For instance, in response to a fault code indicated by the system data 107, the administrator device 175 can automatically transmit a command to power off a portion of the VLSS 100 or disable specific position(s) of a given vehicle platform or a given vehicle lift. In this manner, specific fault codes can be handled automatically without human intervention and by minimally affecting the continued operations of the VLSS 100. In other examples, the one or more programs that monitor the system data 107 can be executed by the edge computer such that the automatic powering off of portions of the VLSS 100 can be performed locally without the need for a network connection.

Still further, the administrator device 175 and/or the server 185 can query for specific information relating to the operation and performance of the VLSS 100 via queries transmitted over the network 180. For example, the queries can relate to the performance, maintenance data, or faults of a specific vehicle lift or a specific motor. In response, the edge computer or the CCU 105 can transmit system data 107 that indicate the requested information. In this manner, the system administrator 170 can remotely take actions to, for example, disable specific vehicle lifts or platform positions within the VLSS 100 based on maintenance data (e.g., information indicating number of cycles since last service) or fault codes.

FIG. 2 is a block diagram illustrating a central control unit (CCU) within a vehicle lift and storage system having distributed control and power networks, in accordance with examples described herein. In the below description of FIG. 2, reference may be made to features and examples shown and described with respect to FIG. 1. For instance, CCU 200 of FIG. 2 can be an example implemented as CCU 105 of FIG. 1.

Referring to FIG. 2, central control unit (CCU) 200 can be implemented on a vehicle lift and storage system (VLSS) such as VLSS 100 of FIG. 1. The CCU 200 can control various higher level functionalities of the VLSS on which it is implemented, such as receiving user requests to store or retrieve vehicles, authenticating users, communicating with user devices, communicating with a network-based service (e.g., a cloud service for managing reservations across a plurality of vehicle storage facilities), determining a vehicle storage assignment in response to a user request to store a vehicle, maintaining a record of vehicles being stored in the VLSS (e.g., associating users and/or vehicles to vehicle storage assignment records), querying a vehicle storage assignment in response to a user request to retrieve a vehicle, maintaining troubleshooting and maintenance data for the VLSS, receiving and processing remote commands from system administrators, and the like.

According to embodiments, the CCU 200 can be implemented on a VLSS having a distributed architecture that includes a central control unit (CCU 200) and a plurality of distributed control units (DCUs) (e.g., DCUs 240 and 250). Each of the DCUs controls one or more respective vehicle lifts—as illustrated, DCU 240 can control vehicle lift 245 and DCU 250 can control vehicle lift 255. As illustrated in FIG. 2, CCU 200 can be coupled to DCU 240 via a low voltage/high voltage interconnect (LV/HV Intcon 280) that has both a low voltage component 280-1 for carrying data and commands and a high voltage component 280-2 for carrying high voltage power (e.g., 480 V three-phase AC current) for providing power to motors of the vehicle lifts 245 and 255. As an alternative, DCU 240 can be coupled to CCU 200 to communicate with CCU 200 (e.g., to receive and/or transmit data, commands, etc.) and to high voltage power supply 270 to receive high voltage power (e.g., for powering motors for moving the vehicle platforms of vehicle lift 245). Via the low voltage component 280-1 of LV/HV Intcon 280, the CCU 200 can transmit commands (e.g., command 216) to the DCUs to instruct the DCUs to cause moving mechanism associated with the DCUs to move a given vehicle platform to a desired position (e.g., in order to retrieve or store a vehicle). The command 216 to the DCUs can be transmitted via a control network input/output (I/O) 235. In addition to commands, the low voltage component 280-1 of LV/HV Intcon 280 can be configured to carry sensor data (e.g., sensor data 253), maintenance data (e.g., maintenance data 252), troubleshooting information, and other information between the CCU 200, the DCUs, and/or other components of the VLSS. Command 216 can be addressed to DCU 250 via a unique control network address (CNA) for DCU 250. The CCU 200 can query the CNA for DCU 250 using a database 220 accessible to the CCU 200. For example, the respective CNA of each component of the VLSS that communicates on the control network can be stored in and retrieved from the database 220 as control network addresses 226. In the configuration illustrated in FIG. 2, the CCU 200 can transmit command 216 to DCU 250 via DCU 240.

In the examples described herein, the CCU 200 can include a network interface 225 for communicating with user devices operated by users (e.g., user device 195 operated by user 190 of FIG. 1) over one or more networks (e.g., the Internet). The user devices can execute a dedicated user application (e.g., user application 196 of FIG. 1) using which a user can submit a request 299 to store or retrieve his or her vehicle on the VLSS. The user device can transmit location data 297 and a user ID 298 to the CCU 200 as part of the request 299. The location data 297 can be generated by a location-aware resource of the user device (e.g., GPS, GLONASS, Galileo, and/or BeiDou receiver) and can indicate a current location of the user. The user ID 298 can be a unique identifier or authentication token for the user at the VLSS or within the network-based service.

Depending on the implementation, the CCU 200 can include supervisory control 215 which can function as a central hub or processor of the CCU 200 to receive and process requests and other information. The CCU 200 can further include a database 220 for maintaining vehicle storage assignment records 221, maintenance data records 222, and control network addresses 226. In particular, control network addresses 226 can be maintained for the components of the VLSS that communicate via the control network. The control network implement a message-based protocol (e.g., controller area network or CAN) in which each component on the control network can be addressed using a unique identifier or address. By associating each component (e.g., a given DCU) on the control network with its unique address within the database 220, the CCU 200 is able transmit data and/or commands to any component on the control network.

According to embodiments, the CCU 200 can process the user request 299 to store or retrieve a vehicle. In doing so, the supervisory control 215 can receive the user request 299, authenticate the user, determine or retrieve a vehicle platform assignment for the user request 299, identify a DCU based on the vehicle platform assignment, retrieve the DCU's control network address (CNA), and transmit a command to the DCU via the control network. In response to receiving the command, the DCU will cause one or more moving mechanisms to move vehicle platforms such that the desired vehicle storage or retrieval operation can be completed. According to embodiments, the CCU 200 can include a vehicle storage assignment engine 260 to assign a vehicle lift (or a specific vehicle platform on a vehicle lift) for a vehicle in response to a request for vehicle storage. The vehicle storage assignment engine 260 can determine vehicle storage assignment based on information indicated by the request 299, including, for example, the user's ID, the amount of time the vehicle is to be stored, etc. The vehicle storage assignment 261 generated by the vehicle storage assignment engine can indicate a vehicle platform identifier.

In certain implementations, the CCU 200 can include an AV interface 230 for interfacing with autonomous vehicles (AVs). The supervisory control 215 can generate AV instructions 217 for transmission to an AV. The AV instructions 217 can be transmitted via the one or more networks 290 or can be transmitted via a local network (e.g., Wi-Fi or Bluetooth) or a dedicated wireless communication channel. The AV instructions 217 can cause the AV to enter and exit the vehicle lift 245 (e.g., pull into or pull out of a vehicular access position). Thus, as part of the vehicle storage and/or retrieval operations, the control system 210 can direct the AV to autonomously drive itself onto or off the vehicle lift 245.

Additional functionalities of the CCU 200 are described with respect to the processes illustrated in FIGS. 4 and 5 below.

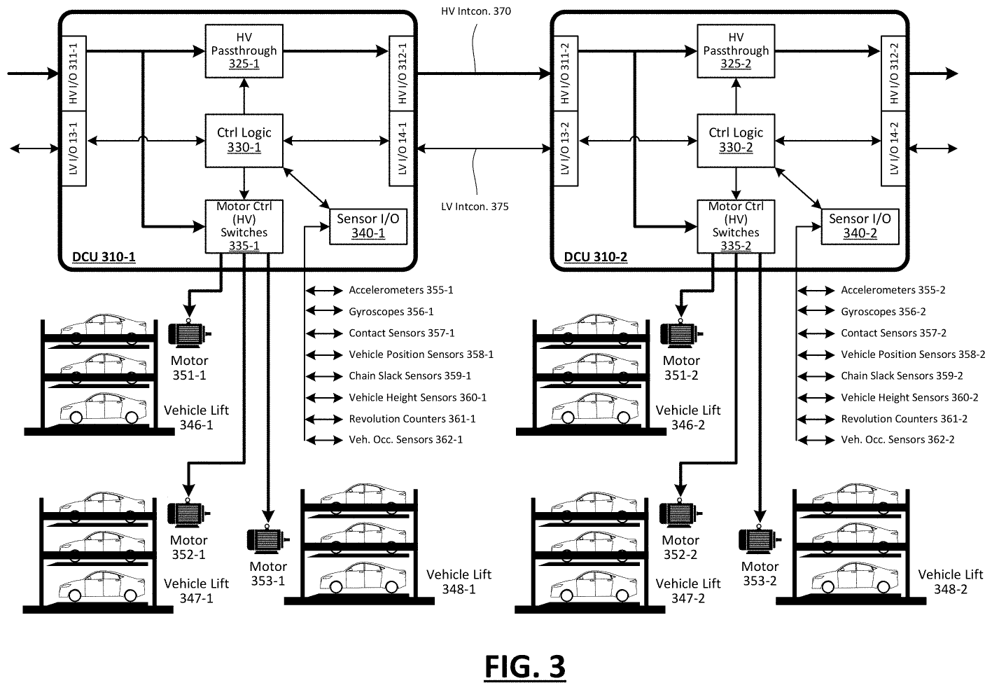

FIG. 3 is a block diagram illustrating distributed control units within a vehicle lift and storage system having distributed control and power networks, in accordance with examples described herein. In the below description of FIG. 3, reference may be made to features and examples shown and described with respect to FIG. 1. For instance, DCUs 310-1 and 310-2 can be examples implemented as one or more of DCUs 125, 130, 135, 140, 145, 150, 155, and 160 of FIG. 1.

In the example illustrated in FIG. 3, two DCUs 310-1 and 310-2 are coupled in a similar manner as described as described above with respect to FIGS. 1 and 2 to implement a distributed and modular VLSS architecture. The DCUs 310-1 and 310-2 are daisy chained with respect to both the high voltage network (via High Voltage Interconnect 370) and the control network (via Low Voltage Interconnect 375). More specifically, DCU 310-2 can communicate with the CCU (e.g., CCU 105 of FIG. 1 or CCU 200 of FIG. 2) via DCU 310-1 and DCU 310-2 can receive high voltage power (e.g., for powering and operating the motors associated with the DCU 310-2: motors 351-2, 352-2, 353-2) via DCU 310-1. Low voltage signals transmitted on the control network of the VLSS (e.g., commands from the CCU, sensor data, control signals, maintenance data, error codes, troubleshooting data, etc.) are transmitted between DCU 310-1 and DCU 310-2 via the Low Voltage Interconnect 375 and high-voltage power is transmitted from DCU 310-1 to DCU 310-2 via the high voltage interconnect 370.

DCU 310-1 can be associated with and can control a plurality of vehicle lifts, including vehicle lifts 346-1, 347-1, and 348-1. DCU 310-1 can also control a plurality of motors that operate to move one or more vehicle platforms and/or safety gates within those vehicle lifts, including motors 351-1, 352-1, and 353-1. For instance, motor 351-1 can move one or more vehicle platforms (and/or safety gates) within vehicle lift 346-1, motor 352-1 can move one or more vehicle platforms (and/or safety gates) within vehicle lift 347-1, and motor 353-1 can move one or more vehicle platforms (and/or safety gates) within vehicle lift 348-1. Similarly, DCU 310-2 can be associated with and can control a plurality of vehicle lifts, including vehicle lifts 346-2, 347-2, and 348-2. DCU 310-2 can also control a plurality of motors that operate to move one or more vehicle platforms and/or safety gates within those vehicle lifts, including motors 351-2, 352-2, and 353-2. For instance, motor 351-2 can move one or more vehicle platforms (and/or safety gates) within vehicle lift 346-2, motor 352-2 can move one or more vehicle platforms (and/or safety gates) within vehicle lift 347-2, and motor 353-2 can move one or more vehicle platforms (and/or safety gates) within vehicle lift 348-2.

In various aspects, DCUs 310-1 and DCU 310-2, like described above with respect to the DCUs implemented within VLSS 100 of FIG. 1, can be modular and can be interchangeable with each other and with other DCUs with similar functionality, such as any of DCUs 125, 130, 135, 140, 145, 155, and 160 of FIG. 1. Thus, within the VLSS 100, if any of the DCUs 125, 130, 135, 140, 145, 155, and 160 malfunctions, the malfunctioning DCU can be quickly replaced with another DCU without any loss in functionality. Furthermore, in accordance with the distributed and modular architecture of the VLSS described herein, DCU 310-1 and DCU 310-2 can be identical components. Thus, in the below descriptions of DCUs 310-1 and 310-2, any description of the physical components of DCU 310-1 can be equally applicable to DCU 310-2. For instance, DCUs 310-1 and DCU 310-2 each includes a plurality of high voltage inputs/outputs (HV I/O) (311-1, 311-2, and 312-1, 312-2, respectively) a high voltage (HV) passthrough (325-1 and 325-2, respectively), control logic (330-1 and 330-2, respectively), a set of motor control switches (355-1 and 355-2, respectively), and sensor input/output (340-1 and 340-2, respectively).

The DCU 310-1 can receive high voltage power (from another DCU or from a high voltage power source) via the High Voltage I/O 311-1. The high voltage power received via the High Voltage I/O 311-1 can be utilized to power one or more of motors 351-1, 352-1, or 353-1 controlled by the DCU 310-1. Motor 351-1 can be operatively coupled (e.g., via a mechanical chain, or via gears) to move one or more vehicle platforms (vertically, transversely, or both) or a safety gate within vehicle lift 346-1. Motors 352-1 and 353-1 are similarly configured to move one or more vehicle platforms or safety gates within vehicle lifts 347-2 and 348-2, respectively. The DCU 310-1 can operate the motor 351-1 by activating and deactivating High Voltage Motor Control Switches 335-1. In certain implementations, the High Voltage Motor Control Switches 335-1 are contactors in which low voltage signals from the control logic of the DCU 310-1 is used to switch the high voltage power to the motors 351-1, 352-1, and 353-1.

In the examples described herein, the DCU 310-1 can further passthrough high voltage power to other DCUs, such as to DCU 310-2 via a second High Voltage I/O 312-1. In the example illustrated in FIG. 3, the DCUs 310-1 and 310-2 are coupled via the High Voltage Interconnect 370 such that the DCU 310-1 can passthrough high voltage power it receives via High Voltage I/O 311-1 to the DCU 310-2. The DCU 310-1 can include the high voltage passthrough 325-1 to safely passthrough high voltage power to DCU 310-2. The High Voltage Passthrough 325-1 can comprise a plurality of high voltage switches (e.g., contactors) that are controlled by the Control Logic 330-1. The High Voltage Passthrough 325-1 can be activated to pass high voltage power or can be deactivated to not pass high voltage power based on whether the High Voltage I/O 321-1 is properly coupled to another DCU (e.g., DCU 310-2) via a High Voltage Interconnect (e.g., High Voltage Interconnect 370). In particular, the Control Logic can, as part of a pre-operation connection test, detect whether the High Voltage I/O 312-1 is properly coupled to the High Voltage I/O 311-2 of DCU 310-2 using one or more low voltage pins and lines within the High Voltage I/O 311-1 and High Voltage Interconnect 370. For instance, a low voltage detection signal can be passed through these pins and lines in order to determine whether there is an open or closed circuit at High Voltage I/O 312-1. Alternatively or in addition, a handshake procedure using one or more handshake protocol messages can be passed between High Voltage I/O 312-1 and High Voltage I/O 311-2 to determine whether High Voltage I/O 312-1 of DCU 310-1 is properly coupled to DCU 311-2. In some examples, the DCUs can be coupled using a combination interconnect that includes both signal lines from the control network and the high voltage network. In such examples, the verification of a proper connection can be performed using control network signals. Furthermore, upon detecting that the High Voltage I/O 321-1 is coupled to another High Voltage I/O, such as High Voltage I/O 311-2 of DCU 310-2 (e.g., via a handshake protocol), the Control Logic 330-1 can perform one or more additional checks to determine whether the High Voltage Interconnect 370 can properly handle the voltage and/or current required to carry high voltage power to DCU 310-2. For instance, the Control Logic 330-1 can iteratively increment the voltage and/or the current on the High Voltage Interconnect 370 as part of the pre-operation connection test until a predetermined threshold voltage and/or current is reached. If errors are detected prior to the threshold voltage and/or current is reached, the Control Logic can cause the High Voltage Passthrough 325-1 to block the high voltage power from reaching High Voltage Interconnect 370.

In the examples described herein, the Control Logic 330-1 can further activate or deactivate the High Voltage Passthrough 325-1 based on a command transmitted by a CCU (e.g., CCU 105 of FIG. 1 and/or CCU 200 of FIG. 2). As a specific example, in the event that a fault is detected at DCU 310-2 (e.g., based on specific error codes transmitted from the DCU 310-2 to the CCU via the control network), the CCU can transmit one or more commands to DCU 310-1 to cause the DCU 310-1 to block high voltage power to be passed to DCU 310-2. In this manner, in response to detecting a fault that may damage components of the VLSS if high voltage power continued to be transmitted (e.g., a short circuit fault), the CCU can cause high voltage power to be cut from specific portions of the VLSS that are affected by the fault. In this manner, damage caused by these types of faults can be mitigated and the distributed and modularized architecture of the VLSS enables other portions of the VLSS to continue functioning despite the fault being experienced. As another example, a system administrator (e.g., system administrator 170) can interact with an administrator device (e.g., administrator device 175) to cause the CCU to generate and transmit commands to the DCU 310-1 to cause the DCU 310-1 to, using the High Voltage Passthrough 325-1, to cut high voltage power from the DCU 310-2. This can be done, for example, in anticipation of a technician servicing the DCU 310-2, motors controlled by DCU 310-2 (e.g., motors 351-2, 352-2, 353-2), or another DCU downstream of the DCU 310-2. In this manner, high voltage power can be safely and remotely cut from the portions of the VLSS being serviced or repaired.

In the examples described herein, the DCU 310-1 further includes Sensor I/O 340-1 to receive sensor data from a plurality of sensors provided on or within the vehicle lifts associated with the DCU, such as vehicle lifts 346-1, 347-1, and 348-1. The sensors can include accelerometers 355-1, gyroscopes 356-1, vehicle platform contact sensors 357-1, vehicle position sensors 358-1, chain slack detectors 359-1, vehicle height sensors 360-1, motor revolution counters 361-1, vehicle occupancy sensors 362-1, and the like. Based on sensor data from one or more of the sensors, the Control Logic 330-1 can control the High Voltage Motor Control Switches 335-1 to activate or deactivate motors 351-1, 352-1, and 353-1. For example, during operations to move a particular platform on vehicle lift 346-1, accelerometers 355-1 positioned on the particular platform can detect abnormal or undesired contact experienced by the particular platform. In response to this sensor data, the Control Logic 330-1 can, via the High Voltage Motor Control Switches 335-1, cause the motor 351-1 to stop moving the particular platform and/or reverse to move the platform in the reverse direction to mitigate any damage to the vehicle lift 346-1 or vehicles placed on the vehicle lift 346-1.

In other examples, the DCU 310-1 can forward sensor data received from one or more of the sensors to the CCU via the control network (e.g., via Low Voltage Interconnect 131-1). For instance, revolution counters 361-1 can detect the number of revolutions achieved by the motors 351-1, 352-1, and/or 353-1. The data from the revolution counters 361-1 can be used as maintenance data by the CCU to determine when the motors 351-1, 352-1, and 353-1 need to be serviced. By maintaining the total number of revolutions achieved by the motors 351-1, 352-1, and 353-1 (e.g., revolutions since last service) and a predetermined threshold value (e.g., design specification of the motors indicating revolutions between service), the CCU can determine when the a specific one of the motors 351-1, 352-1, and/or 353-1 need to be serviced. In this manner, the CCU can preemptively inform the system administrator 170 of the need for a particular one of the motors to be serviced based on usage history. Furthermore, as another example, the CCU can implement a wear-leveling program to determine vehicle storage assignments in vehicle lifts based on wear of components of the vehicle lifts such that the components such as the motors 351-1, 352-1, and/or 353-1 reach their designed service intervals approximately contemporaneously. As a more specific example, if a particular motor (e.g., motor 352-1 being further from its designated service interval based on a maintained revolution count determined based on data generated by the revolution counters 361-1), the CCU can determine vehicle storage assignments to utilize vehicle lift 347-1 more often than the other vehicle lifts by, for example, assigning vehicles to be stored in vehicle lift 347-1 more often and/or assigning short-term storage assignments that require more frequent motor operations to vehicle lift 347-1. In this manner, the wear on the motors 351-1, 352-1, and 353-1 can be leveled such that the all the motors reach their designed service interval approximately contemporaneously than otherwise achievable. This can reduce service cost and downtime.

Methodology

FIGS. 4 and 5 are flow charts describing example methods of performing a vehicle storage operation and a vehicle retrieval operation, respectively, according to examples described herein. The methods illustrated and described in FIGS. 4 and 5 can be performed by an example VLSS (e.g., VLSS 100 of FIG. 1), a central control unit (e.g., CCU 105 of FIG. 1 or CCU 200 of FIG. 2) implemented as a component of a VLSS, or one or more distributed control units (e.g., DCU 125 of FIG. 1 or DCU 310-1 of FIG. 3). Accordingly, in the below description of FIGS. 4 and 5, reference may be made to features and examples shown and described with respect to FIGS. 1 to 3.

Referring to FIG. 4, the CCU 200 can receive a user request 299 to store the user's vehicle (410). The user request 299 can include identification information of the user (e.g., user ID 298) and the user's location data (e.g., location data 297). The user request 299 can be received from a user console or kiosk (e.g., authentication terminal 115) located at or near the VLSS (411). Such a request can be generated based on the user interacting with a user interface (e.g., a touchscreen user interface) presented at the user console or kiosk. Alternatively, the user request 299 to store the user's vehicle can also be received by the CCU 200 via the network interface 225 over one or more networks (412). Depending on the implementation, the request 299 can be transmitted by a user device 195 (e.g., user interacting with a user application 196 executing on the user device 195 to cause the user device 195 to transmit the request 299) or by a server 185 implementing a cloud or network-based service for managing reservations at one or more VLSS's (e.g., user interacting with the user application 196 to cause the user device 195 to transmit a request to the server 185 which in turn transmits the request 299 to the VLSS and CCU 200). The request 299 can further correspond to a wireless signal (e.g., encoded or rolling code RF signals, Bluetooth, etc.) transmitted by a wireless key fob in the possession of the user.

According to embodiments, the CCU 200, in response to receiving the request 299, authenticates the user (415). For example, the CCU 200 can communicate with the server 185 of FIG. 1 via network interface 225 to authenticate the user. In other examples, the CCU 200 can access database 220 to authenticate the user. In an implementation where the request 299 is generated by the server 185, the authentication process can have already been performed by the server 185 implementing the cloud or network-based service. In such an implementation, the CCU 200 need not perform step 415 in response to receiving the request 299. In yet another implementation where the CCU 200 can receive both requests generated both by the server 185 and by other means (e.g., by a user kiosk located in proximity to the VLSS, by a user device, or by a wireless key fob in possession of the user, etc.), the CCU 200 can determine, based on the request 299, whether and/or how to perform the authentication process. For example, if the request 299 generated by a user kiosk includes an indication that the user 190 is registered with the cloud or network-based service, the CCU 200 can communicate with the server 185 to perform the authentication process. On the other hand, if the CCU 200 determines that the request 299 (or the user 190 who submitted request 299) is not associated with the cloud or network-based service, the CCU 200 can authenticate the user 190 based on information stored within the database 220.

The CCU 200 can determine, based on the request 299, whether a vehicle storage assignment has been predetermined for the user (420). A vehicle storage assignment (e.g., indicating a specific vehicle lift and/or vehicle platform, etc.) can be predetermined based on the user 190's selections in interacting with the user application 196 or a user terminal 115. For instance, the user 190 can, via the user application or the user terminal 115, select to store his or her vehicle in a specific area of the VLSS (e.g., a premium parking area for extra cost). The vehicle storage assignment can also be predetermined based on the user 190's profile information (e.g., on-going privileges or subscriptions for reserved parking, etc.).

If the user 190 does not have a predetermined vehicle storage assignment, the CCU 200 can determine a vehicle storage assignment for the user 190's vehicle (425). The vehicle storage assignment can be determined based on the request 299 (e.g., a time duration for vehicle storage indicated by the request 299). For instance, if the requested time duration is short (e.g., less than an hour), the CCU 200 can determine to move the user's vehicle to a position close to a vehicular access position for easy retrieval after the requested duration is complete. On the other hand, if the requested time duration is long, the CCU 200 can determine to move the vehicle to a storage position that is further away from the vehicular access positions of the VLSS such that other vehicles that will be stored in the VLSS for shorter periods of time can be placed near the vehicular access positions.

Based on the vehicle storage assignment (e.g., either predetermined or determined at step 425), the CCU 200 can identify a corresponding DCU (430). Each of the plurality of DCUs of the VLSS is associated with one or more vehicle lifts and one or more moving mechanisms. These associations can be stored in the database 220 of the CCU 200. The CCU 200 can identify the appropriate DCU for moving the desired vehicle platform (e.g., as indicated by the vehicle storage assignment) by querying for the control network address of the DCU. Using the retrieved control network address, the CCU 200 can transmit a command (or set of commands) to the relevant DCU (435).

As an example, the CCU 200 can identify vehicle lift 255 within the VLSS as the vehicle storage assignment for the request 299 (or a specific platform, a specific column, etc. of vehicle lift 255). The CCU 200 can further determine that the DCU 250 is associated with the vehicle lift 255 (e.g., the DCU 250 controls the motors that operate the vehicle lift 255's safety gate and vehicle platforms). Based on this determination, the CCU 200 can query the command network addresses (CNAs) 226 stored in the database 220 for the CNA of DCU 250 (e.g., DCU CNA 223). Using the retrieved DCU CNA 223, the supervisory control 215 can generate a command 216 that is addressed to DCU 250 to instruct the DCU 250 to cause the motors of the vehicle lift 255 to operate as desired (e.g., move an unoccupied vehicle platform to a vehicle access position, open the safety gate, close the safety gate, etc.).

After the operation to store the vehicle has completed (e.g., the vehicle lift movement has completed and/or the safety gate of the vehicle lift has moved back in position), the DCU that performed the vehicle storage operations can transmit a confirmation (e.g., confirmation 251 of FIG. 2) to the CCU 200. The CCU 200 can store the vehicle storage assignment for the vehicle as a part of the vehicle storage assignment records 221. For instance, the CCU 200 can associate a unique identifier of the user with the vehicle storage assignment such that the vehicle storage assignment can be queried during a vehicle retrieval operation (e.g., as illustrated in FIG. 5).

Referring to FIG. 5, the CCU 200 can receive a user request 299 to retrieve the user's vehicle (510). The user request 299 can include identification information of the user (e.g., user ID 298). The user request 299 can be received from a user console or kiosk (e.g., authentication terminal 115) located at or near the VLSS (511). Such a request can be generated based on the user interacting with a user interface (e.g., a touchscreen user interface) presented at the user console or kiosk. Alternatively, the user request 299 to retrieve the user's vehicle can also be received by the CCU 200 via the network interface 225 over one or more networks (512). Depending on the implementation, the request 299 can be transmitted by a user device 195 (e.g., user interacting with a user application 196 executing on the user device 195 to cause the user device 195 to transmit the request 299) or by a server 185 implementing a cloud or network-based service for managing reservations at one or more VLSS's (e.g., user interacting with the user application 196 to cause the user device 195 to transmit a request to the server 185 which in turn transmits the request 299 to the VLSS and CCU 200). As another alternative, the request 299 can correspond to a wireless signal (e.g., encoded or rolling code RF signals, Bluetooth, etc.) transmitted by a wireless key fob in the possession of the user.

According to embodiments, the CCU 200, in response to receiving the request 299 to retrieve the user's vehicle, authenticates the user (515). The authentication can be performed in a manner similar to the one described with respect to FIG. 4 (e.g., step 415).

The CCU 200 is further configured to retrieving a vehicle storage assignment (VSA) in response to receiving the request 299 of the user to retrieve the user's vehicle (or in response to authenticating the user at step 515) (520). The VSA of the user's vehicle can be retrieved from a database accessible to the CCU 200 (e.g., database 220 of FIG. 2). For instance, the database 220 can maintain a plurality of VSA records 221 for the vehicles stored within the VLSS. The each of the VSA records 221 can be stored within the database 220 during a respective vehicle storage operation. The CCU 200 can further update the a corresponding one of the VSA records 221 when a respective vehicle is moved within the VLSS (e.g., during operations to move or store another vehicle).

Based on the retrieved VSA for the requesting user, the CCU 200 can identify the corresponding DCU (525) and transmit a command to the DCU via the control network (530) to cause the DCU to move the vehicle lift(s) to retrieve the vehicle. Once the vehicle storage operation is complete, the CCU 200 can receive a confirmation from the DCU and update the VSA records (535). For instance, the VSA record associated with the requesting user can be deleted from VSA records 221 in the database 220 after the requesting user's vehicle has be successfully retrieved from the VLSS. In certain implementations, during the vehicle retrieval process 500, the CCU 200 can transmit, over one or more networks to the requesting user's mobile computing device, information relating to the vehicle retrieval operation. For example, after retrieving the VSA of the requesting user's vehicle, the CCU 200 can transmit information relating to the location of the user's vehicle (e.g., a parking stall number, a location within the parking structure) and/or where the user can retrieve the vehicle (e.g., the vehicular access location at which the vehicle will be placed after the retrieval process and/or walking directions thereto, etc.).

Hardware Diagram

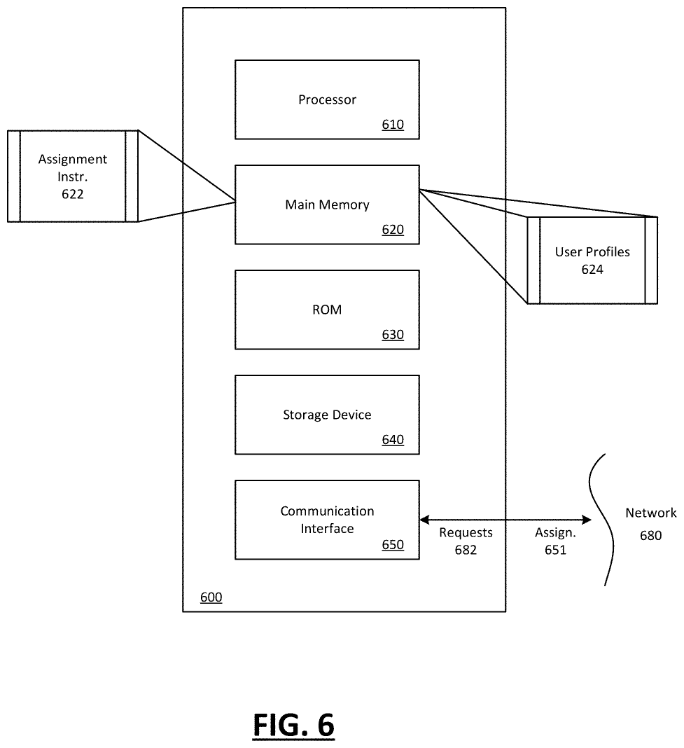

FIG. 6 is a block diagram that illustrates a computer system upon which examples described herein may be implemented. A computer system 600 can be implemented on, for example, a server or combination of servers. For example, the computer system 600 may be implemented as part of a network service managing connected VLSS's. In the context of FIG. 1, the server 185 may be implemented using a computer system 600 such as described by FIG. 6. The server 185 may also be implemented using a combination of multiple computer systems as described in connection with FIG. 6.

In one implementation, the computer system 600 includes processing resources 610, a main memory 620, a read-only memory (ROM) 630, a storage device 640, and a communication interface 650. The computer system 600 includes at least one processor 610 for processing information stored in the main memory 620, such as provided by a random-access memory (RAM) or other dynamic storage device, for storing information and instructions which are executable by the processor 610. The main memory 620 also may be used for storing temporary variables or other intermediate information during execution of instructions to be executed by the processor 610. The computer system 600 may also include the ROM 630 or other static storage device for storing static information and instructions for the processor 610. A storage device 640, such as a magnetic disk or optical disk, is provided for storing information and instructions.

The communication interface 650 enables the computer system 600 to communicate with one or more networks 680 (e.g., cellular network) through use of the network link (wireless or wired). Using the network link, the computer system 600 can communicate with one or more computing devices, one or more servers, and/or one or more self-driving vehicles. In accordance with examples, the computer system 600 receives requests 682 from computing devices of individual users. The executable instructions stored in the memory 630 can include assignment instructions 622, which the processor 610 executes to determine dynamic parking assignments in response to requests for vehicle storage received from users. In doing so, the computer system 600 can receive location data of the user to determine the dynamic assignment 651 in response to the user request 682. The processor 610 is configured with software and/or other logic to perform one or more processes, steps and other functions described with implementations, such as described by FIGS. 1-5, and elsewhere in the present application.

Examples described herein are related to the use of the computer system 600 for implementing the techniques described herein. According to one example, those techniques are performed by the computer system 600 in response to the processor 610 executing one or more sequences of one or more instructions contained in the main memory 620. Such instructions may be read into the main memory 620 from another machine-readable medium, such as the storage device 640. Execution of the sequences of instructions contained in the main memory 620 causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A vehicle lift and storage system comprising:
a plurality of moving mechanisms, each of the plurality of moving mechanisms being configured to move one or more corresponding vehicle platforms for storing vehicles;
a central control unit configured to receive requests to perform vehicle storage or retrieval operations;
a plurality of distributed control units for controlling the plurality of moving mechanisms, wherein each of the plurality of distributed control units is (i) communicatively coupled to the central control unit to receive one or more commands and (ii) configured to control a respective one of the plurality of moving mechanisms in response to the one or more commands received from the central control unit; and
wherein the plurality of distributed control units comprise a first set of distributed control units and a second set of distributed control units, each of the second set of distributed control units being communicatively coupled to the central control unit via a corresponding one of the first set of distributed control units.

2. The vehicle lift and storage system of claim 1, wherein each of the plurality of distributed control units is associated with a corresponding unique identifier and wherein a command transmitted by the central control unit to a first distributed control unit of the plurality of distributed control units is addressed using the corresponding unique identifier of the first distributed control unit.

3. The vehicle lift and storage system of claim 1, further comprising:
a high voltage power source for supplying power to the plurality of moving mechanisms; and
wherein the plurality of distributed control units comprises a first distributed control unit that is coupled to the high voltage power source via a first high voltage interconnect to receive power from the high voltage power source and a second distributed control unit that is coupled to the first distributed control unit via a second high voltage interconnect to receive power via the first distributed control unit.

4. The vehicle lift and storage system of claim 3, wherein the first distributed control unit includes one or more high voltage contactors and is configured to control a first moving mechanism of the plurality of moving mechanisms by selectively transferring power to the first moving mechanism using the one or more high voltage contactors based on the one or more commands received from the central control unit.

5. The vehicle lift and storage system of claim 3, wherein the first distributed control unit includes a set of one or more high voltage switches to selectively transfer power from the high voltage power source to the second distributed control unit via the second high voltage interconnect.

6. The vehicle lift and storage system of claim 3, wherein the first distributed control unit selectively transfers power from the high voltage power source to the second distributed control unit via the second high voltage interconnect in response to successfully performing a handshake sequence with the second distributed control unit.

7. The vehicle lift and storage system of claim 3, wherein the first distributed control unit is configured to stop transferring power from the high voltage power source to the second distributed control unit in response to receiving a first command transmitted by the central control unit to the first distributed control unit.

8. The vehicle lift and storage system of claim 7, wherein the central control unit is configured to transmit the first command to cause the first distributed control unit to stop transferring power from the high voltage power source to the second distributed control unit in response to receiving an error code from the second distributed control unit.

9. The vehicle lift and storage system of claim 7, wherein the central control unit is configured to transmit the first command to cause the first distributed control unit to stop transferring power from the high voltage power source to the second distributed control unit in response to receiving, from an administrator device or an administrator console, an administrator command to power off a portion of the vehicle lift and storage system.

10. The vehicle lift and storage system of claim 1, wherein the central control unit is configured to:
in response to receiving a first request to store a vehicle of a user, determine a vehicle storage assignment for storing the vehicle;
based on the vehicle storage assignment determined for the vehicle, determine a control network identifier associated with a first distributed control unit of the plurality distributed control units; and
transmit the one or more commands over a control network of the vehicle lift and storage system to the first distributed control unit, the one or more commands being addressed to the first distributed control unit using the control network identifier determined based on the vehicle storage assignment.

11. The vehicle lift and storage system of claim 10, wherein the central control unit is further configured to:
receive a confirmation message transmitted by the first distributed control unit over the control network; and
in response to receiving the confirmation message from the first distributed control unit, update a vehicle storage database with the determined vehicle storage assignment.

12. The vehicle lift and storage system of claim 1, wherein the central control unit is configured to:
in response to receiving a first request to retrieve a vehicle of a user, retrieve a vehicle storage assignment of the vehicle from a vehicle storage assignment database maintained by the central control unit;
based on the vehicle storage assignment retrieved for the vehicle, determine a control network identifier associated with a first distributed control unit of the plurality distributed control units; and
transmit the one or more commands over a control network of the vehicle lift and storage system to the first distributed control unit, the one or more commands being addressed to the first distributed control unit using the control network identifier determined based on the vehicle storage assignment.

13. The vehicle lift and storage system of claim 1, wherein a first distributed control unit of the plurality of distributed control (i) comprises one or more high voltage switches for controlling a first moving mechanism to move a first vehicle platform between a plurality of positions, (ii) is configured to receive sensor data from one or more sensors associated with the first vehicle platform, and (iii) is configured to control the first moving mechanism based at least in part on the sensor data received from the one or more sensors.

14. The vehicle lift and storage system of claim 13, wherein the first distributed control unit is configured to control the first moving mechanism based at least in part on the sensor data received from the one or more sensors by:
activating the one or more high voltage switches in response to one or more commands received from the central control unit over a control network of the vehicle lift and storage system; and
deactivating the one or more high voltage switches in response to the sensor data received from the one or more sensors.

15. The vehicle lift and storage system of claim 13, wherein the first distributed control unit is configured to transmit at least a portion of the sensor data to the central control unit over a control network of the vehicle lift and storage system, and wherein the central control unit is configured to store the sensor data received from the first distributed control unit in a database.

16. The vehicle lift and storage system of claim 13, wherein the one or more sensors comprise one or more of: (i) a multi-axis accelerometer, (ii) a gyroscope, (iii) a contact sensor, (iv) a vehicle position sensor, (v) a chain slack sensor, or (vi) a cycle or revolution counter.

17. A vehicle lift and storage system comprising:
a plurality of vehicle lifts;
a central control unit;
a plurality of distributed control units that are configured to, in response to commands transmitted by the central control unit, control a corresponding one of the plurality of the vehicle lifts;
wherein the plurality of vehicle lifts includes a first vehicle lift housing a first set of one or more vehicle platforms, the first set of one or more vehicle platforms of the first vehicle lift being controlled by a first distributed control unit of the plurality of distributed control units in response to commands transmitted by the central control unit; and
wherein the first distributed control unit includes one or more ports for coupling, via one or more interconnects, with a second distributed control unit that is configured to control a second vehicle lift of a plurality of vehicle lifts, the second distributed control unit being configured to communicate with the central control unit and receive high voltage power via the one or more interconnects and the first distributed control unit.

18. The vehicle lift and storage system of claim 17, wherein the first vehicle lift includes a set of wire guides for housing the one or more interconnects that couple the first distributed control unit with the second distributed control unit.

19. A vehicle lift and storage system comprising:
a plurality of moving mechanisms, each of the plurality of moving mechanisms being configured to move one or more corresponding vehicle platforms;
a high voltage power source for supplying high voltage power for powering the plurality of moving mechanisms;
a central control unit;
a plurality of distributed control units that are configured to, in response to commands transmitted by the central control unit, control the plurality of moving mechanisms by selectively transferring power from the high voltage power source to the plurality of moving mechanisms; and
wherein the plurality of distributed control units comprises a first set of distributed control units and a second set of distributed control units, the second set of distributed control units being configured to receive high voltage power and communicate with the central control unit via a respective one of the first set of distributed control units.

20. The vehicle lift and storage system of claim 19, wherein each of the plurality of distributed control units is associated with a corresponding unique identifier and wherein a command transmitted by the central control unit to a first distributed control unit of the plurality of distributed control units is addressed using the corresponding unique identifier of the first distributed control unit.
